(19) United States
(12) Patent Application Publication
(10) Pub. No.: US 2012/0198379 A1
(43) Pub. Date: Aug. 2, 2012

(54) E-BOOK TERMINAL, SERVER, AND SERVICE PROVIDING METHOD THEREOF

(75) Inventors: Chang-won KIM, Asan-si (KR); Sun-wha CHUNG, Seoul (KR); Joo-kyung WOO, Yongin-si (KR); Eun-young LIM, Seoul (KR)

(73) Assignee: Samsung Electronics Co., Ltd., Gyeonggi-do (KR)

(21) Appl. No.: 13/362,923

(22) Filed: Jan. 31, 2012

(30) Foreign Application Priority Data
Jan. 31, 2011 (KR) 10-2011-0009720

(51) Int. Cl. G06F 3/048; G06F 15/16

(52) U.S. Cl. 715/776; 709/217

(57) ABSTRACT

An e-book terminal and a server are provided. The e-book terminal includes a storage unit for storing contents, a display for displaying icons corresponding to the contents and additionally displays updated marks on icons that corresponds to contents containing updated information, and a controller for, if an icon upon which one of the updated marks is additionally displayed is selected, controlling the display unit to display link information on a screen for updated information corresponding to the content of the selected icon.

### PRIORITY

This application claims priority under 35 U.S.C. §119(a) to Korean Patent Application No. 10-2011-0009720, filed in the Korean Intellectual Property Office on Jan. 31, 2011, the entire content of which is incorporated herein by reference.

### BACKGROUND OF THE INVENTION

1. Field of the Invention

The present invention relates generally to an e-book terminal, a server, and a service providing method thereof, and more particularly, to an e-book terminal, a server, and a service providing method thereof adapted to provide updated information.

2. Description of the Related Art

Due to the widespread use of the Internet and recent developments in mobile communication services various information services are being developed. As a result of these developments, videos, such as movies and dramas, books, and music, which were previously mainly provided through offline channels, can be provided through Internet services. Since educational information, living information, medical information, and economic information can be provided through the internet either as paid services or free of charge, information-providing industries have been vitalized.

Among the above-described media, e-books, which provide books that are traditionally published in offline channels through the Internet, are a type of digital content service produced by cutting edge information communication technology. E-books display digitized books produced by means of standard Internet languages such as Hypertext Markup Language (HTML) and Extensible Markup Language (XML) through an e-book terminal, (e.g., a personal computer, a mobile communication terminal, an electronic dictionary, a Portable Multimedia Player (PMP), a dedicated terminal, etc.) by using an e-book viewer.

Distribution of e-books has merits saves production and distribution costs, reduce the burden of publishers' inventories, and enable to obtain books that have been discontinued in a printed format. Moreover, use of e-books can reduce a risk of damaging the books and facilitate in updating the contents of the books.

In order to purchase an e-book, a user can access, through an e-book apparatus accessible to the Internet, an e-book providing server that allows the user to search e-book contents in order to find and purchase desired books.

However, the e-book contents may be partially updated with revised versions of e-books, and various information related to e-books may need to be continuously updated.

Further, as the connections between e-book contents and various Social Networking Services (SNSs) increases, there is a need for an SNS focused on e-book contents and a need for a way to indicate updates to the user's contents.

However, in conventional e-book services, the service provider updates the revised e-books on a server, and users must perform their own updates in order to receive the revised contents.

Even through the connecting functions of existing SNSs, only limited functions exist for sharing information regarding texts read by users, such as through Twitter or Facebook, for example.

Thus, in the conventional e-book terminals, it is not clear which parts of various e-book contents may have been revised, and, if misspelled or omitted terms have been modified, the details of the modifications are unclear.

Further, even if a sharing function over an SNS, such as Twitter or Facebook is provided, additional SNS sharing functions cannot be generated among the users through. Therefore, users cannot perform the “comment exchange” programs, etc. corresponding to e-books.

### SUMMARY OF THE INVENTION

Embodiments of the present invention may, but are not required to address the above-described problems and/or disadvantages, as well as other problems and disadvantages not described above.

According to an aspect of the present invention, an e-book terminal, a server, and a service providing method are adapted to provide updated information in real time.

According to an aspect of the present invention, an e-book terminal is provided. The e-book includes a storage unit for storing contents; a display unit for displaying icons corresponding to each of the contents and additionally displaying updated marks on icons that correspond to contents containing updated information; and a controller for, if an icon upon which one of the updated marks is additionally displayed is selected, controlling the display unit to display link information for updated information corresponding to the content of the selected icon.

According to another aspect of the present invention, a server is provided. The server includes a communication unit for transmitting, to an e-book terminal, when contents of the e-book terminal are updated, updated information including link information identifying updated parts of the contents of the e-book terminal; and a controller for controlling the communication unit to provide the updated parts to the e-book terminal when a request for the updated information based on the link information is received from the e-book terminal.

### BRIEF DESCRIPTION OF THE DRAWINGS

The above and/or other aspects of the present invention will be more apparent by describing certain embodiments of the present invention with reference to the accompanying drawings, in which:

FIG. 1 is a diagram schematically illustrating a construction of a system that provides an e-book update service according to an embodiment of the present invention;

FIGS. 2A and 2B are block diagrams illustrating a construction of an e-book terminal according to an embodiment of the present invention;

FIG. 3 is a block diagram illustrating a construction of a server according to an embodiment of the present invention;

FIGS. 4A to 4D examples of screen displays depicting a method of providing service of an e-book terminal according to an embodiment of the present invention;

FIGS. 5A to 5C are examples of screen displays depicting a service providing method of an e-book terminal according to an embodiment of the present invention;

FIG. 6 is a flowchart illustrating a service providing method of an e-book terminal according to an embodiment of the present invention; and

FIG. 7 is a flowchart illustrating a service providing method of the server according to an embodiment of the present invention.

### DETAILED DESCRIPTION OF EMBODIMENTS OF THE INVENTION

Certain embodiments will now be described in greater detail with reference to the accompanying drawings.

In the following description, the same drawing reference numerals may be used in reference the same elements or similar elements in different drawings. The matters defined in the description, such as detailed construction and elements, are provided to assist in a comprehensive understanding of the invention. Thus, embodiments of the present invention may be implemented with or without some of these specifically defined matters. Well-known functions or constructions may not be described in detail, in order to avoid obscuring the subject matter of invention with unnecessary detail.

FIG. 1 schematically illustrates a construction of a system that provides an e-book update service according to an embodiment of the present invention.

According to FIG. 1, a system for providing an e-book update service according to an embodiment of the present invention includes an e-book terminal 100, a server 200, and a wire/wireless communication network 10.

The e-book terminal 100 is a portable terminal (e.g. a cellular phone, a Personal Digital Assistant (PDA), etc.) having a memory to store e-books and information such as PDA data and/or other digital data.

The e-book terminal 100 can be equipped with a wired/wireless communication unit 140 that enables the wired/wireless communication over a wired/wireless communication network 10.

In particular, the e-book terminal 100 may access a server 200 through the wired/wireless communication network and download e-book contents from the server 200. The e-book terminal 100 stores downloaded e-book contents and displays e-book contents selected by the user through an e-book viewer program.

The wired/wireless communication network 10 can transmit and receive data by protocols such as Internet Protocol (IP) utilizing various wired/wireless communication techniques such as Internet networking, intranet networking, mobile communications networking, and satellite communications networking, etc. As various techniques for performing wired/wireless communication are well-known, a detailed description thereof is omitted.

The server 200 provides updated information to the e-book terminal 100. The server 200 can be embodied by at least one content providing server that provides updated content substance information and/or SNS servers that provide SNS information related to the contents. Updated content substance information refers to revised/modified content substance, and the SNS information related to the contents refers to user comments corresponding to relevant contents that are provided through the SNS servers such as Twitter or Facebook.

The content providing server can provide in addition to updated content substance information, the contents itself. The content providing server can store and manage various e-book contents (e.g. philosophy, liberal arts, science, religion, IT, sports, and history) in an e-book content database and can also provide the stored e-book contents to the e-book terminal 100 at a certain cost or free of charge.

In the present example according to an embodiment of the present invention, the server 200 stores and manages all of the contents and the updated content substance information. However this storage is merely a non-limiting example. For instance, the server 200 may only store and manage the update information, while another server separately stores and manages the contents.

The contents can be provided from a distributor's server that receives and distributes contents from the publisher, and the updated information of the content substances can be provided through a publisher's server. In this case, the distributor's server may merely provide information indicating that content substances have been updated.

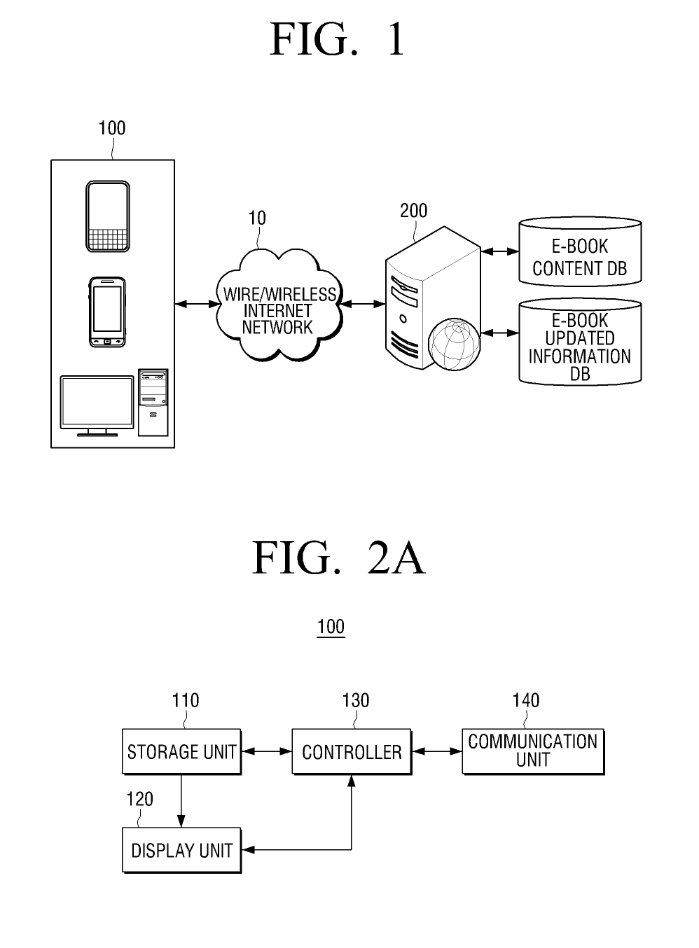

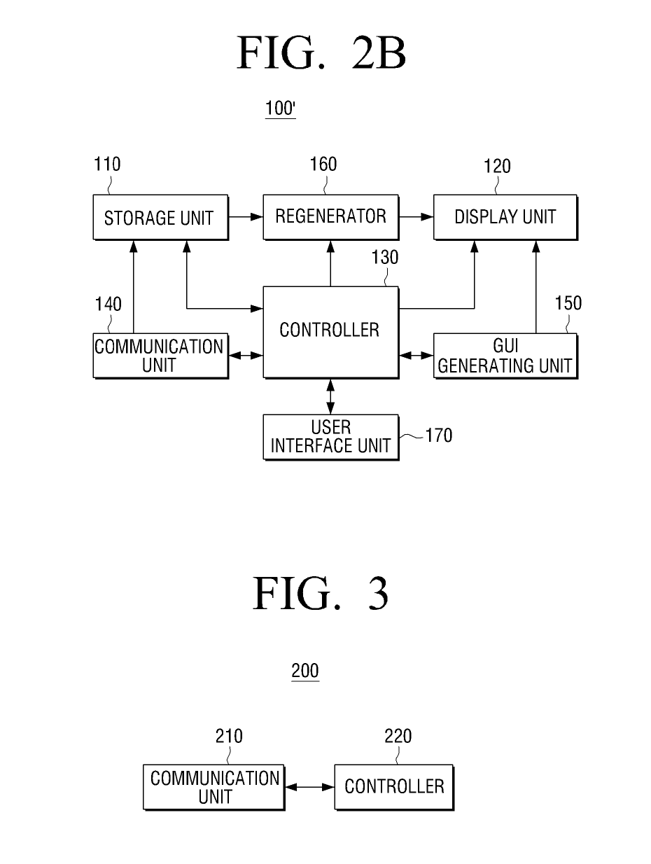

FIGS. 2A and 2B are block diagrams illustrating a construction of an e-book terminal according to an embodiment of the present invention.

According to FIG. 2A, the e-book terminal 100 includes a storage unit 110, a display unit 120, a controller 130, and a communication unit 140.

The storage unit 110 stores various programs and data required to activate the e-book terminal 100. For example, the storage unit 110 can store an e-book viewer program that provides e-book contents in a visible form for the user.

The storage unit 110 can provide a storage space where the contents are stored. In this case, the contents stored in the storage unit 100 may include still images, video, e-books, etc. The storage unit 110 may be either of a built-in storage element or a detachable storage element.

The display unit 120 shows icons corresponding to contents and can additionally show “updated marks”, i.e., additional marks on the icons corresponding to the contents that have updated information.

The display unit 120 can be a display such as a liquid crystal display, a thin film transistor-liquid crystal display, an organic light-emitting diode, a flexible display, a three-dimensional (3D) display, etc.

If an icon on which an updated mark is additionally shown is selected, the controller 130 can control the display unit 120 to display link information for the updated substance.

The communication unit 140 communicates through a server (not shown) or a wired/wireless communication network.

According to a user's orders and/or preset events, the controller 130 controls the overall functions of the e-book terminal 100 by executing various programs stored in the storage unit 110. For example, the controller 130 can control the e-book contents to be displayed through the display unit 120 by activating the e-book viewer program.

If the updated information is received from the server 200 (see FIG. 1), the controller 130 can control the display unit 120 to additionally show the updated marks on the icons corresponding to the contents related to the received updated information. As described above with respect to FIG. 1, the server 200 can be at least one of a content providing server and an SNS server.

The updated information can be at least one of updated content substance information provided from the content providing server and updated SNS information related to contents provided from the SNS server.

Further, if an icon on which the updated mark is additionally shown is selected, the controller 130 displays a cover screen of the contents corresponding to the icon and may control the display unit 120 to display link information on the cover screen. If link information is displayed, the controller 130 can control the link information to be displayed according to the page order of the contents.

The controller 130 can control the display unit 120 to display an updated content page corresponding to the link information selected from the link information displayed on the display unit 120.

The controller 130 can also control the display unit 120 to display an SNS site corresponding to the link information selected from the displayed link information.

FIG. 2B is a block diagram illustrating a detailed construction of an e-book terminal of FIG. 2A according to an embodiment of the present invention.

According to FIG. 2B, an e-book terminal 100′ includes the storage unit 110, the display unit 120, the controller 130, the communication unit 140, a Graphical User Interface (GUI) generating unit 150, a regenerator 160, and a user interface unit 170. Additional detailed descriptions of components already described with

In addition to the functions and operations described herein with respect to FIG. 2A, the display unit 120 can be a touch screen type that forms an interactive layer with a touch pad. In such a case, the display unit 120 can additionally function as the user interface unit 170. The touch screen can be configured to detect the position and area of a touch input as well as the pressure of the touch input.

The GUI generating unit 150 generates a GUI, which may be added to the contents displayed on the display unit 120.

More specifically, the GUI generating unit 150 generates a GUI providing link information corresponding to the received updated information, and can add the received updated information to the contents. Under the control of the controller 130, the GUI generating unit 150 can perform 2D/3D conversion of GUI elements, and can also adjust transparency, color, size, adjustment of the shape and the position, highlights, and animation effects of the GUI elements.

The regenerator 160 regenerates and outputs the contents stored in the storage unit 110. If the contents in the storage unit 110 are stored in a compressed format, the regenerator 160 can decompress the compressed contents and output the decompressed contents.

The user interface unit 170 is an input means receiving instructions from a user and transmit the received instructions to the controller 130. The user interface unit 170 may include an input panel. The input panel may be a touch pad, a touch screen, or a keypad, and may be equipped with various functional keys, numeral keys, special keys, and letter keys. Through the input panel, a user may input instructions for selecting link information among the link information displayed on the display unit 120.

The input panel may also include an operation button for receiving input of a user request for predetermined e-book contents selected by the user from among e-book contents stored in the storage unit 110. The input panel may further include a movement button to move the e-book content substance, in pages and lines, displayed on the display unit 120, and a close button for closing currently opened e-book contents.

FIG. 3 is a block diagram illustrating a construction of a server according to an embodiment of the present invention.

Referring to FIG. 3, the server 200 includes a communication unit 210 and a controller 220.

The server 200 transmits updated information to the e-book terminals (such as e-book terminals 100 and 100′ of FIG. 2A FIG. 2B, respectively). The updated information can be at least one of the updated information of the content substance and the SNS updated information related to the contents. The server 200 may be at least one of the content server and the SNS server. For example, if the server 200 is embodied by a content providing server, the server 200 can store and manage contents and updated information of the content substance and transmit the contents and updated information to an c-book terminal, if necessary. However, the content providing server that provides the updated content substance information may be embodied separately from a server that provides updated content information.

The content providing server may be a distributor's server that receives and distributes contents from a publisher, and the updated content information providing server may be a publisher's server that provides revised/modified content substances. The server that receives and distributes the contents from the publisher may also store and manage all of the contents as well as the updated content information.

If the server 200 is includes an SNS server, the server 200 can store and manage the updated SNS information related to the contents and provide, to the e-book terminal, the updated substance information or state information indicating whether content substance information has been updated. However, if the SNS server is updated, the server 200 informs the e-book terminal of the updated state of the SNS server and, if there is an update request from the e-book terminals 100 and 100′, the update can be performed by connecting to the SNS server to provide the updated content substance.

The communication unit 210 communicates with the e-book terminal the via wired/wireless communication network. If the contents are updated, the communication unit 210 transmits the updated information including link information, which allows the e-book terminal to identify the updated parts from among the contents stored in the e-book terminal.

If a request for identification corresponding to the updated information is received from the e-book terminal, the controller 220 controls the communication unit 210 to provide the requested updated parts to the e-book terminal based on the link information.

For example, if there is a request for identification corresponding to the updated information particular of content substance from the e-book terminal, the controller 220 can provide the revised/modified content parts, e.g., a relevant updated e-book content page, to the e-book terminal.

Otherwise, if there is a request for identification corresponding to updated SNS information related to particular contents, the controller 220 can provide, to the e-book terminal, SNS substance information, such as comments on the particular contents.

According to an embodiment of the present invention, it is assumed that one server informs the e-book terminal an updating occurrence and provides the updated information in detail (i.e. the revised/modified content substance and the updated SNS substances). However, this server arrangement is merely an example, and servers according to other embodiments of the present invention may include a server for informing the e-book terminal of the update, and another separate server for providing the updated information in detail to the e-book terminal.

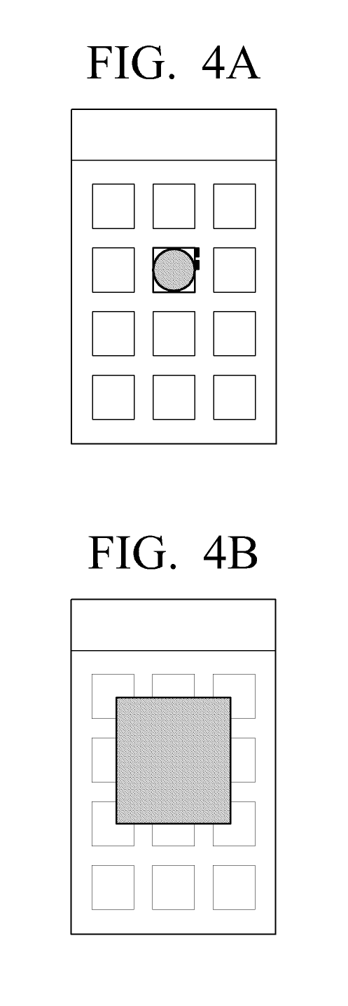

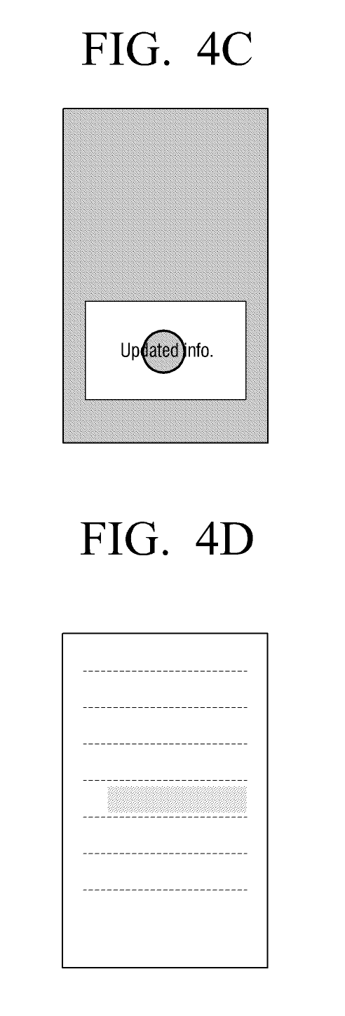

FIGS. 4A to 4D illustrate a service providing method of an e-book terminal according to an embodiment of the present invention.

First, an icon corresponding to e-book content stored in an e-book terminal is displayed, and an updated mark corresponding to content that has updated information can be additionally shown on a corresponding icon. Under this condition, an icon on which the updated mark is additionally displayed can be selected according to user input. Here, the updated information can be received from a server, which can be at least one of the content providing server and the SNS server. The updated information may include at least one of the updated content substance information and the updated SNS information related to the contents. The updated content substance information can be the revised/modified content substance, and the updated SNS information related to the contents can be the user's comments corresponding to the contents. More specifically, when a user has e-book contents with highlights or comments corresponding to the substance of the content, and if another user (an SNS friend) leaves a message as replies or comments corresponding to the e-book contents, the substance of the e-book contents can be updated with the message from the other user, and the user having the e-book contents may be informed of the updates in real time.

As shown in FIG. 4B, contents corresponding to a selected icon can be magnified and positioned at a center of a display region. For example, the cover screen of the relevant content can be magnified and displayed on the screen. As an alternative, it can be partially magnified and displayed on the screen.

As shown in FIG. 4C, a cover screen may be displayed at the center of link information related to the updated information. The updated information can be at least one of updated content substance information and updated SNS information related to the contents.

Then, if any one of the displayed link information is selected from among the displayed link information, it can be moved to a designated page and be shown as in FIG. 4D.

As an alternative, after the selected page is identified, the displayed image may return to the previous screen (a screen displayed before the link information was displayed) or to a next page, and then a selected one can be displayed according to the user's option.

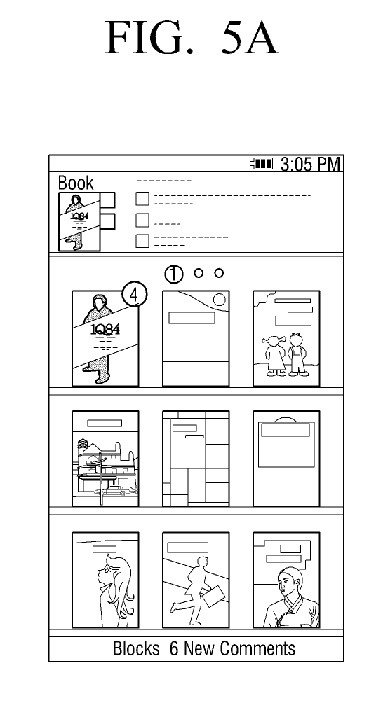

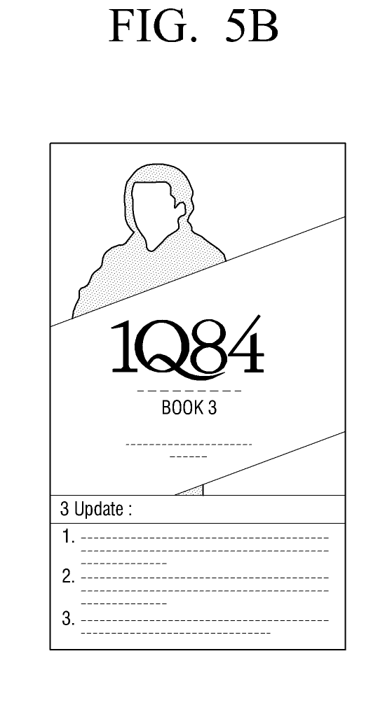

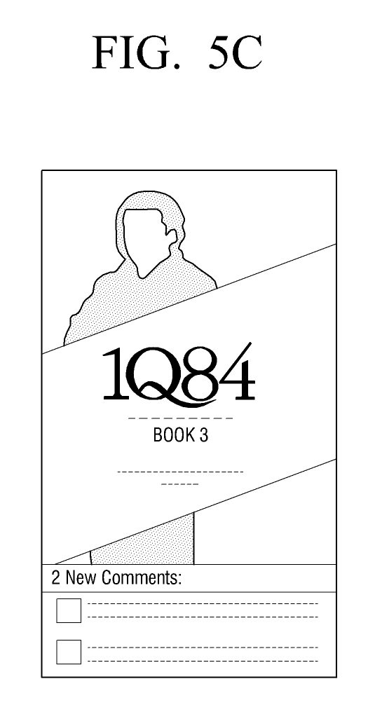

FIGS. 5A to 5C depict screen displays corresponding to a service providing method of an e-book terminal according to an embodiment of the present invention.

As shown in FIG. 5A, a plurality of icons corresponding to stored e-book content is displayed. On one of the icons, an updated mark (\textcircled{4}) indicating updated information corresponding to one of the contents is additionally displayed. Here, the numeral within the updated mark may indicate the number of the updated substance items corresponding to the particular content. In the present example, the updated mark (\textcircled{4}) indicates that there are four updated substance items.

If the user selects an icon on which the updated mark is additionally displayed (e.g., the icon including the mark (\textcircled{4}) in FIG. 5A), the content cover corresponding to the selected icon is displayed across the screen. As shown in FIGS. 5B and 5C, the updated information can be displayed together with the cover.

More specifically, the updated information can be updated content substance such as shown in FIG. 5B, and/or the updated information can be SNS substance related to the contents, such as shown in FIG. 5C.

Although the updated information is displayed at a lower portion of the cover in the examples according to FIGS. 5B and 5C, the position on which the updated information shown in the drawing can be embodied in various manners and positions on the screen depending on circumstances in accordance with embodiments of the present invention.

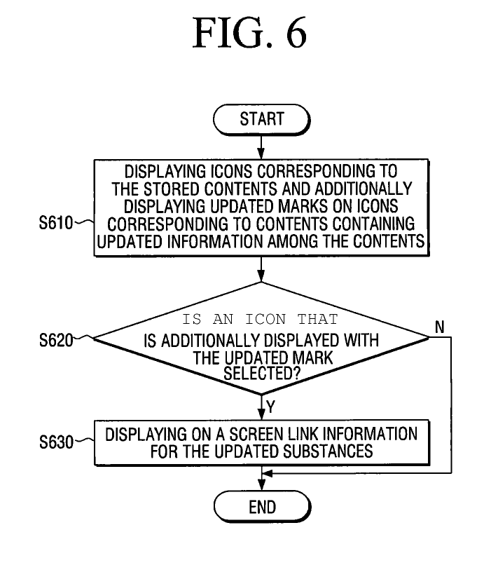

FIG. 6 is a flowchart illustrating a service providing method of an e-book terminal according to an embodiment of the present invention.

Referring to FIG. 6, an updated mark is additionally displayed on an icon corresponding to stored content to indicate that the content has the updated information, in step S610. The updated mark corresponds to the contents related to updated information received from a server.

If the icon on which the updated mark is additionally displayed is selected, in step S620, link information for the updated substances is displayed on the screen in step S630. For example, in step S630, the cover screen of the content corresponding to the icon may be displayed across the screen along with the link information.

The link information can be displayed in the page order of the contents. The link information can also be moved to updated content pages or the SNS site that corresponds to the selected link information and can be displayed on the updated content pages or SNS site, respectively. In this example, the server can include at least one of the content providing server and the SNS server, and the updated information may include at least one of the updated information of the content substance and the SNS updated information related to the contents.

For example, the updated information of the content substance may be revised/modified content substance information, and the SNS updated information related to the contents can be comments or replies from SNS users.

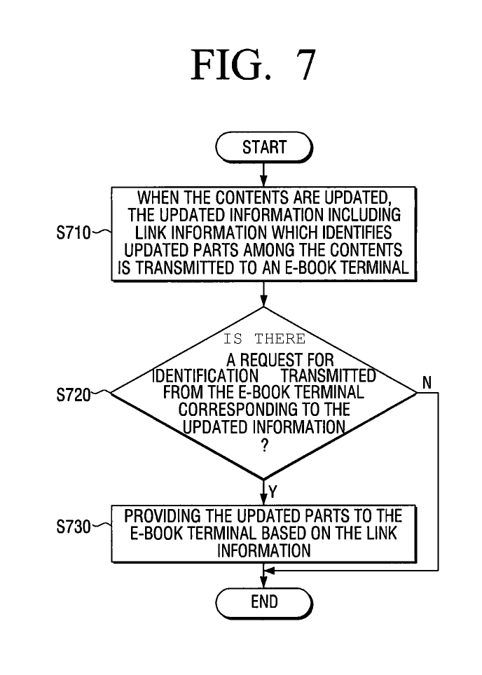

FIG. 7 is a flowchart illustrating a service providing method of a server according to an embodiment of the present invention.

Referring to FIG. 7, once contents of an e-book terminal are updated, the updated information, including link information that identifies the updated parts, is transmitted to the e-book terminal, in step S710.

If it is determined that the request for identification corresponding to the updated information is transmitted from the e-book terminal in step S720, the updated parts are transmitted to the e-book terminal based on the link information. The server may include at least one of a content providing server and an SNS server.

The updated information may include at least one of updated content substance information transmitted by the content providing server and updated SNS information related to the contents transmitted by the SNS server.

The updated substance related to the e-book content (e.g., a revised book substance, modified particular, and other SNS information related to the e-book) can be provided to a user through the e-book application in real time.

The user of the e-book terminal user is not required to re-purchase or re-download e-book content that has been revised can automatically receive only the updated substance as revised parts of the e-book. Moreover, a user may check which parts of the e-book are revised, as well as check the particular manner in which these parts have been revised.

By updating related substance information periodically during use of an SNS corresponding to the e-book contents, any comments from friends corresponding to the e-book contents may be checked instantly.

The foregoing embodiments and advantages are merely provided as examples and are not to be construed as limiting the present invention. The present teaching can be readily applied to other types of apparatuses. Also, the description of the embodiments of the present invention is intended to be illustrative, and not to limit the scope of the claims, and many alternatives, modifications, and variations will be apparent to those skilled in the art.

1. (canceled)

2. (canceled)

3. (canceled)

4. (canceled)

5. (canceled)

6. (canceled)

7. (canceled)

8. (canceled)

9. (canceled)

10. (canceled)

11. (canceled)

12. (canceled)

13. (canceled)

14. (canceled)

15. (canceled)

16. (canceled)

17. (canceled)

18. (canceled)

19. (canceled)

20. (canceled)

21. An e-book terminal, comprising:
a storage unit for storing content;
a display unit for displaying icons corresponding to each of the content and additionally displaying updated marks on icons that correspond to content containing updated information; and
a controller for, if an icon upon which one of the updated marks is additionally displayed is selected, controlling the display unit to display link information for updated information corresponding to the content of the selected icon.

22. The terminal as claimed in claim 21, further comprising:
a communication unit for communicating with a server,
wherein, when the updated information is received from the server, the controller controls the display unit to additionally display the updated marks on the icons corresponding to content related to the updated information.

23. The terminal as claimed in claim 21, wherein, if the icon on which the updated mark is additionally displayed is selected, the controller controls the display unit to display a cover screen of the content corresponding to the selected icon and to display the link information on the cover screen.

24. The terminal as claimed in claim 22, wherein the server includes at least one of a content providing server and a Social Networking Service (SNS) server, and
wherein the updated information includes at least one of updated content substance information and updated SNS information related to the content.

25. The terminal as claimed in claim 24, wherein the controller controls the display unit to display an updated content page corresponding to link information selected from the displayed link information.

26. The terminal as claimed in claim 24, wherein the controller controls the display unit to display an SNS site corresponding to link information selected from the displayed link information.

27. The terminal as claimed in claim 21, wherein the controller controls the display unit to display the link information in a page order of the content.

28. A server comprising:
a communication unit for transmitting, to an e-book terminal, when content of the e-book terminal are updated, updated information including link information identifying updated parts of the content of the e-book terminal; and
a controller for controlling the communication unit to provide the updated parts to the e-book terminal when a request for the updated information based on the link information is received from the e-book terminal.

29. The server as claimed in claim 28, wherein the server includes at least one of a content providing server and a Social Networking Service (SNS) server.

30. The server as claimed in claim 28, wherein the updated information includes at least one of updated information of the content substance and SNS updated information related to the content.

31. A service providing method of an e-book terminal comprising:
displaying icons corresponding to stored content and additionally displaying updated marks on icons that correspond to content containing updated information; and
displaying, if an icon upon which one of the updated marks is additionally displayed is selected, link information for updated information corresponding to the content of the selected icon.

32. The method as claimed in claim 31, further comprising:
receiving the updated information from a server,
wherein additionally displaying the updated marks includes additionally displaying updated marks on icons corresponding to content when the updated information is received.

33. The method as claimed in claim 31, further comprising:
displaying a cover screen of content corresponding to the selected icon and displaying the link information on the cover screen.

34. The method as claimed in claim 32, wherein the server includes at least one of a content providing server and a Social Networking Service (SNS) server, and
wherein the updated information includes at least one of updated content substance information and updated SNS information related to the contents.

35. The method as claimed in claim 34, further comprising:
displaying an updated content page corresponding to link information selected from the displayed link information.

36. The method as claimed in claim 34, further comprising:
displaying an SNS site corresponding to link information selected from the displayed link information.

37. The method as claimed in claim 31, wherein displaying the link information displays the link information in a page order of the content.

38. A service providing method of a server comprising:
transmitting to an e-book terminal, when content of the e-book terminal are updated, updated information including link information identifying updated parts of the content of the e-book terminal; and
providing, to the e-book terminal, the updated parts when a request for the updated information based on the link information is received from the e-book terminal.

39. The method as claimed in claim 38, wherein the server includes at least one of a content providing server and a Social Networking Service (SNS) server.

40. The method as claimed in claim 38, wherein the updated information includes at least one of updated content substance information and updated SNS information related to the content.
